(19) United States
(12) Patent Application Publication
(10) Pub. No.: US 2025/0390406 A1
(43) Pub. Date: Dec. 25, 2025

(54) METHOD AND SYSTEM FOR AUTOMATIC VALIDATION OF DATA DELIVERY

(71) Applicant: JPMorgan Chase Bank, N.A., New York, NY (US)

(72) Inventors: Brandon CALHOUN, Austin, TX (US); Vijay SHETTY, Powell, OH (US); John LOEFFLER, Westerville, OH (US); Mitesh SHAH, Frisco, TX (US)

(73) Assignee: JPMorgan Chase Bank, N.A., New York, NY (US)

(21) Appl. No.: 18/750,660

(22) Filed: Jun. 21, 2024

(51) Int. Cl. G06F 11/30; G06F 11/32

(52) U.S. Cl. CPC G06F 11/3072; G06F 11/321

(57) ABSTRACT

A method and a system for automatically generating audit records of data transfer events in order to validate data delivery and to facilitate monitoring and compliance with applicable regulations are provided. The method includes: receiving a notification that an event has commenced; obtaining information that relates to the event, including information that relates to a data transfer that occurs in connection with the event and information that relates to an intended destination and an intended timing of the data transfer; submitting, to a records repository, a request for records that relate to the event; receiving the records; comparing the information that relates to the event with the records; generating, based on a result of the comparison, an audit report that relates to the event; and transmitting the audit report to a predetermined destination.

### BACKGROUND

### 1. Field of the Disclosure

This technology generally relates to methods and systems for validating data delivery, and more particularly to methods and systems for automatically generating audit records of data transfer events in order to validate data delivery and to facilitate monitoring and compliance with applicable regulations.

### 2. Background Information

In a large organization, there are many circumstances that entail transfers of data. Typically, it is important to be able to track and monitor events for which such transfers occur, in order to make sure that the right data is delivered to the right place at the right time, and also to facilitate an ability to conduct audits and comply with applicable governmental regulations.

In the absence of a dedicated system for tracking and monitoring data transfer events, the ability to perform such tracking and monitoring may be resource intensive and time consuming, and may also be prone to errors and/or missing or inadequate information. In addition, when an error occurs, such an error may not be detected in a timely manner, and affected persons may be unaware of the error for a length of time.

Accordingly, there is a need for a mechanism for automatically generating audit records of data transfer events in order to validate data delivery and to facilitate monitoring and compliance with applicable regulations.

### SUMMARY

The present disclosure, through one or more of its various aspects, embodiments, and/or specific features or sub-components, provides, inter alia, various systems, servers, devices, methods, media, programs, and platforms for automatically generating audit records of data transfer events in order to validate data delivery and to facilitate monitoring and compliance with applicable regulations.

According to an aspect of the present disclosure, a method for automatically generating an audit report for an event is provided. The method is implemented by at least one processor. The method includes: receiving, by the at least one processor, a notification that a first event has commenced; obtaining, by the at least one processor, first information that relates to the first event; submitting, by the at least one processor to a records repository, a first request for at least one record that relates to the first event; receiving, by the at least one processor in response to the first request, the at least one record; comparing, by the at least one processor, the first information with the at least one record; generating, by the at least one processor based on a result of the comparing, an audit report that relates to the first event; and transmitting, by the at least one processor to at least one predetermined destination, the audit report.

The first information may include information that relates to a data transfer that occurs in connection with the first event and information that relates to an intended destination and an intended timing of the data transfer.

When the result of the comparing indicates that the first information is accurate and that the data transfer has been successful, the audit report may include information that relates to an actual destination and an actual timing of the data transfer.

When the result of the comparing indicates that there is an error associated with the first event, the audit report may include an error alert and the predetermined destination may include a work station that is associated with at least one user that is affected by the error.

The method may further include displaying the audit report on a digital dashboard that functions as a user interface (UI) for a user that is associated with the predetermined destination.

The method may further include displaying, in conjunction with the audit report on the digital dashboard, second information that relates to an entirety of a customer journey that relates to the first event.

The method may further include generating, based on the first information and the audit report, a response to a request to prove compliance with an applicable governmental regulation.

The obtaining of the first information may be performed by extracting the first information from an interaction with a customer that corresponds to the first event.

The method may further include capturing a legal consent from the customer to indicate that the customer has successfully received correct and complete data as a result of the interaction.

According to another embodiment, a computing apparatus for automatically generating an audit report for an event is provided. The computing apparatus includes a processor; a memory; a display; and a communication interface coupled to each of the processor, the memory, and the display. The processor is configured to: receive, via the communication interface, a notification that a first event has commenced; obtain first information that relates to the first event; submit, to a records repository, a first request for at least one record that relates to the first event; receive, in response to the first request via the communication interface, the at least one record; compare the first information with the at least one record; generate, based on a result of the comparison, an audit report that relates to the first event; and transmit, to at least one predetermined destination via the communication interface, the audit report.

The first information may include information that relates to a data transfer that occurs in connection with the first event and information that relates to an intended destination and an intended timing of the data transfer.

When the result of the comparison indicates that the first information is accurate and that the data transfer has been successful, the audit report may include information that relates to an actual destination and an actual timing of the data transfer.

When the result of the comparison indicates that there is an error associated with the first event, the audit report may include an error alert and the predetermined destination may include a work station that is associated with at least one user that is affected by the error.

The processor may be further configured to cause the display to display the audit report on a digital dashboard that functions as a user interface (UI) for a user that is associated with the predetermined destination.

The processor may be further configured to cause the display to display, in conjunction with the audit report on the digital dashboard, second information that relates to an entirety of a customer journey that relates to the first event.

The processor may be further configured to generate, based on the first information and the audit report, a response to a request to prove compliance with an applicable governmental regulation.

The processor may be further configured to obtain the first information by extracting the first information from an interaction with a customer that corresponds to the first event.

The processor may be further configured to capture a legal consent from the customer to indicate that the customer has successfully received correct and complete data as a result of the interaction.

According to yet another embodiment, a non-transitory computer readable storage medium storing instructions for automatically generating an audit report for an event is provided. The storage medium includes a set of executable code which, when executed by a processor, causes the processor to: receive a notification that a first event has commenced; obtain first information that relates to the first event; submit, to a records repository, a first request for at least one record that relates to the first event; receive, in response to the first request, the at least one record; compare the first information with the at least one record; generate, based on a result of the comparison, an audit report that relates to the first event; and transmit, to at least one predetermined destination, the audit report.

The first information may include information that relates to a data transfer that occurs in connection with the first event and information that relates to an intended destination and an intended timing of the data transfer.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system, according to an embodiment.

FIG. 2 illustrates a network diagram of a network environment, according to an embodiment.

FIG. 3 illustrates a system diagram of a system, according to an embodiment.

FIG. 4 illustrates a process diagram of a process for automatically generating audit records of data transfer events, according to an embodiment.

FIG. 5 illustrates a flow diagram for automatically generating audit records of data transfer events, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

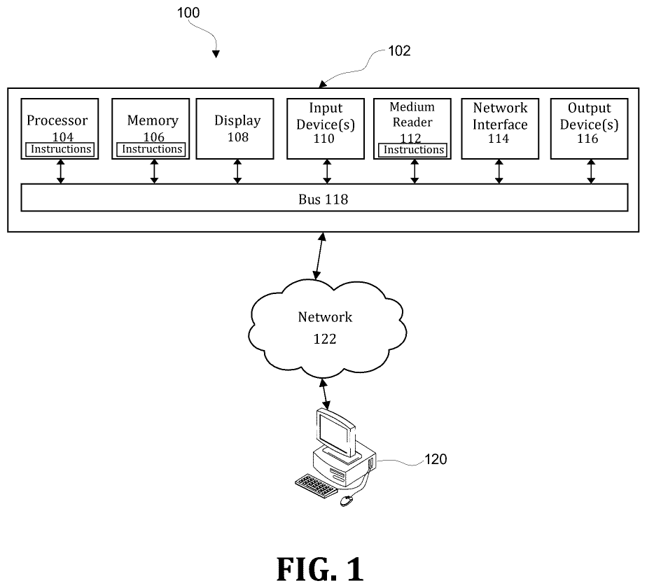

FIG. 1 illustrates a system diagram of a system 100 in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically generating audit records of data transfer events in order to validate data delivery and to facilitate monitoring and compliance with applicable regulations.

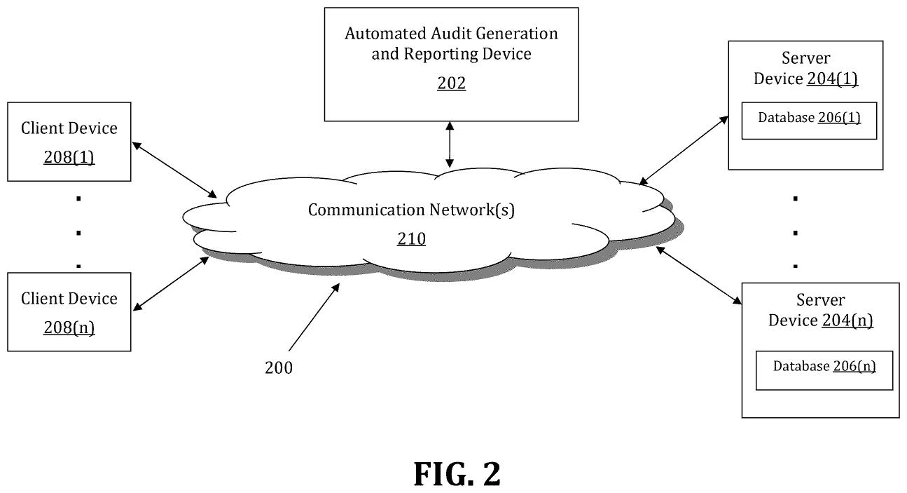

Referring to FIG. 2, a schematic of a network environment 200 for implementing a method for automatically generating audit records of data transfer events in order to validate data delivery and to facilitate monitoring and compliance with applicable regulations is illustrated. In some embodiments, the method may be executable on any networked computer platform, such as, for example, a personal computer (PC).

The method for automatically generating audit records of data transfer events in order to validate data delivery and to facilitate monitoring and compliance with applicable regulations may be implemented by an Automated Audit Generation and Reporting (AAGR) device 202. The AAGR device 202 may be the same or similar to the computer system 102 as described with respect to FIG. 1. The AAGR device 202 may store one or more applications that may include executable instructions that, when executed by the AAGR device 202, cause the AAGR device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AAGR device 202 itself, may be located in virtual server(s) running in a cloud-based computing environment rather than being tied to one or more specific physical network computing devices. Also, the application(s) may be running in one or more virtual machines (VMs) executing on the AAGR device 202. Additionally, in one or more embodiments, virtual machine(s) running on the AAGR device 202 may be managed or supervised by a hypervisor.

In the network environment 200 of FIG. 2, the AAGR device 202 may be coupled to a plurality of server devices 204(1)-204(n) that hosts a plurality of databases 206(1)-206(n), and also to a plurality of client devices 208(1)-208(n) via communication network(s) 210. A communication interface of the AAGR device 202, such as the network interface 114 of the computer system 102 of FIG. 1, may operatively couple and communicate between the AAGR device 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AAGR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AAGR devices that efficiently implement a method for automatically generating audit records of data transfer events in order to validate data delivery and to facilitate monitoring and compliance with applicable regulations.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AAGR device 202 may be a standalone device or integrated with one or more other devices or apparatuses, such as one or more of the server devices 204(1)-204(n), for example. In one particular example, the AAGR device 202 may include or be hosted by one of the server devices 204(1)-204(n), and other arrangements are also possible. Moreover, one or more of the devices of the AAGR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AAGR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to data transfer events and information that relates to systems of records that are usable for checking and confirming data accuracy.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AAGR device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AAGR device 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the AAGR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are mere examples, as many variations of the specific hardware and software used to implement the examples are possible, as will be appreciated by those skilled in the relevant art(s).

One or more of the devices depicted in the network environment 200, such as the AAGR device 202, the server devices 204(1)-204(n), or the client devices 208(1)-208(n), for example, may be configured to operate as virtual instances on the same physical machine. In other words, one or more of the AAGR device 202, the server devices 204(1)-204(n), or the client devices 208(1)-208(n) may operate on the same physical device rather than as separate devices communicating through communication network(s) 210. Additionally, there may be more or fewer AAGR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

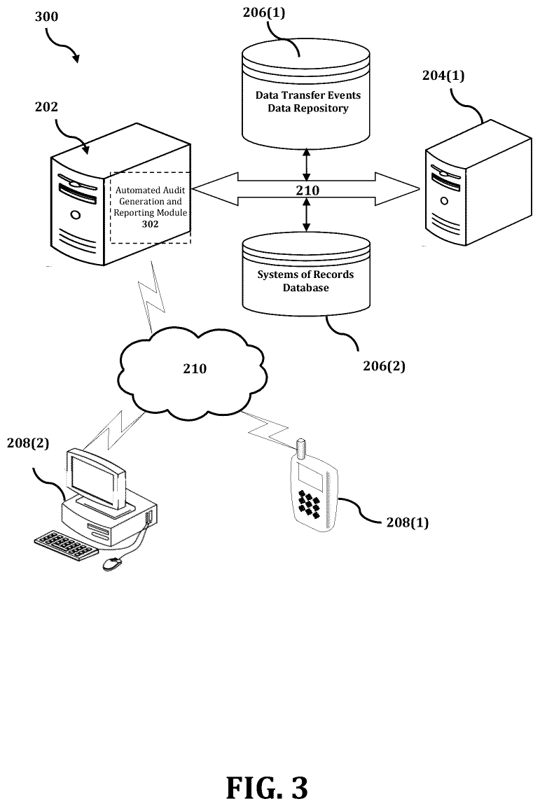

The AAGR device 202 is described and illustrated in FIG. 3 as including an automated audit generation and reporting (AAGR) module 302, although it may include other rules, policies, modules, databases, or applications, for example. As will be described below, the AAGR module 302 may be configured to implement a method for automatically generating audit records of data transfer events in order to validate data delivery and to facilitate monitoring and compliance with applicable regulations.

A system 300 for implementing a mechanism for automatically generating audit records of data transfer events in order to validate data delivery and to facilitate monitoring and compliance with applicable regulations by utilizing the network environment of FIG. 2 is illustrated in FIG. 3. Specifically, a first client device 208(1) and a second client device 208(2) are illustrated as being in communication with AAGR device 202. In this regard, the first client device 208(1) and the second client device 208(2) may be “clients” of the AAGR device 202 and are described herein as such. Nevertheless, it is to be known and understood that the first client device 208(1) and/or the second client device 208(2) need not necessarily be “clients” of the AAGR device 202, or any entity described in association therewith herein. Any additional or alternative relationship may exist between either or both of the first client device 208(1) and the second client device 208(2) and the AAGR device 202, or no relationship may exist.

Further, AAGR device 202 is illustrated as being able to access a data transfer events data repository 206(1) and a systems of records database 206(2). The automated audit generation and reporting module 302 may be configured to access these databases for implementing a method for automatically generating audit records of data transfer events in order to validate data delivery and to facilitate monitoring and compliance with applicable regulations.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the AAGR device 202 via broadband and/or cellular communication. Of course, these embodiments are not limiting or exhaustive.

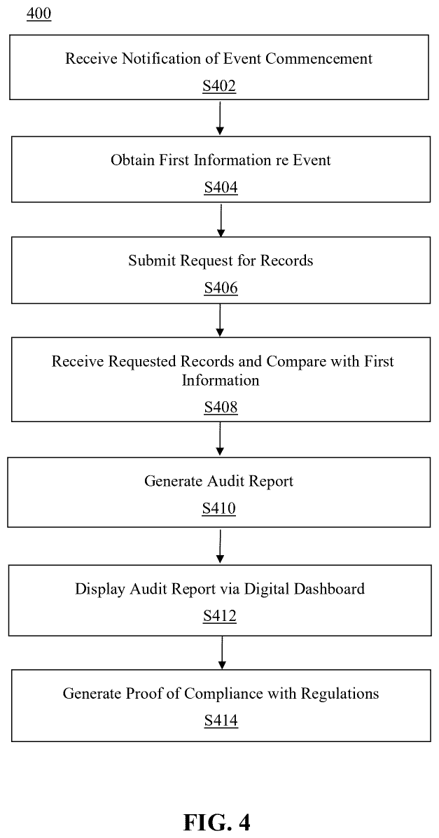

Upon being started, the AAGR module 302 may execute a process for automatically generating audit records of data transfer events in order to validate data delivery and to facilitate monitoring and compliance with applicable regulations. Referring to FIG. 4, a process for automatically generating audit records of data transfer events in order to validate data delivery and to facilitate monitoring and compliance with applicable regulations is illustrated according to an embodiment.

In process 400 of FIG. 4, at step S402, the AAGR module 302 may receive a notification that an event has commenced. In an embodiment, the event may include, for example, a message from a customer that indicates an intention to have an interaction, such as an account opening or a commercial transaction. In an embodiment, the event involves a data transfer.

At step S404, the AAGR module 302 may obtain information that relates to the event. In an embodiment, the information that relates to the event may include information that relates to the data transfer that occurs in connection with the event, and also may include an intended destination and an intended timing of the data transfer. In an embodiment, the obtaining of the information that relates to the event may be performed by extracting the information from a customer interaction that corresponds to the event. For example, when the event includes a reception of a message from a customer, the information may be extracted from the message.

At step S406, the AAGR module 302 may submit a request for one or more records that relate to the event to a records repository, such as systems of records database 206(2). Then, at step S408, the AAGR module 302 may receive the requested records and compare the records with the information that relates to the event obtained in step S404, in order to make a determination as to whether the information that relates to the data transfer accurately reflects the information that is stored in the records repository.

At step S410, the AAGR module 302 may generate an audit report that relates to the event based on a result of the comparison from step S408. Then, at step S412, the AAGR module 302 may transmit the audit report to one or more predetermined destinations, such as, for example, to users of systems that are associated with the event, and then display the audit report on a digital dashboard that functions as a user interface (UI).

In an embodiment, when the result of the comparison indicates that the information that relates to the event is accurate and that the data transfer has been successful, the audit report may include information that relates to an actual destination and an actual timing of the data transfer. In this scenario, the AAGR module 302 may also communicate with a recipient of the data being transferred in connection with the event, such as a customer, to request a legal consent indicating that the customer has successfully received correct and complete data as a result of the interaction that corresponds to the event. Conversely, when the result of the comparison indicates that there is an error associated with the event, the audit report may include an error alert, which may be transmitted to a work station that is associated with a user that could be affected by the error.

In an embodiment, in conjunction with the displaying of the audit report on the digital dashboard, the AAGR module 302 may also display additional information that relates to an entirety of a customer journey that relates to the event. For example, when the event is a continuation of an ongoing interaction with a customer, the digital dashboard may display both the current audit report and the history of the ongoing interaction in order to facilitate an effective response to the customer and the event.

At step S414, the AAGR module 302 may use the information that relates to the event obtained in step S404 and the audit report generated in step S410 to generate a response to a request to prove compliance with an applicable governmental regulation. For example, for certain types of customer interactions, there may be an applicable know-your-customer (KYC) regulation, and the information relating to the event and the audit report may contain much or all of the information that is required for proving compliance with such a regulation.

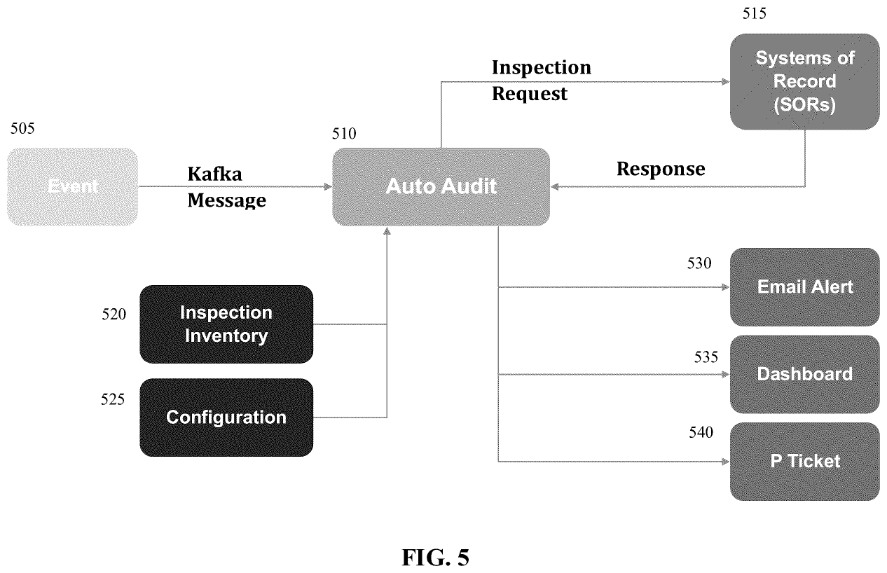

FIG. 5 is a flow diagram 500 that corresponds to a system and method for automatically generating audit records of data transfer events, according to an embodiment. As illustrated in flow diagram 500, an auto audit module may receive an event 505 and/or a notification that an event is occurring, such as a Kafka message, from an event module.

Referring again to FIG. 5, in response to the reception of the event 505, the auto audit module 510 may generate and submit an inspection request to a systems of records module 515. In this aspect, in generating the inspection request, the auto audit module 510 may retrieve inspection-related information from an inspection inventory module 520 and/or configuration information from a configuration module 525. As a result, the auto audit module 510 may receive a response that includes the requested records. In an embodiment, the inspection request may refer to any of various types of inspections, such as, for example, a legal agreement consent capture, an e-coupon reception and application, a tax withholding status, a KYC information capture, a customer identification program (CIP) snapshot, an auto lending customer information reconciliation, a signature card creation and storage, a debit card issuance, a rush card order fulfillment, and/or any other suitable type of inspection.

Referring again to FIG. 5, in an embodiment, the auto audit module 510 then automatically generates an audit report based on the event 505 received from the event module and the records received in response to the inspection request. The resulting audit report may then be transmitted to one or more destinations, such as, for example, a digital dashboard 535 of a user. The audit report may also be transmitted in conjunction with an email alert message 530 and/or an incident ticket or production ticket (also referred to herein as a “P ticket”) 540 to a user that may be affected by the event 505. For example, when the audit report indicates that an error has occurred in connection with the event 505, the email alert 530 may be sent to a user that may be affected by the error, or the P ticket 540 may be sent to a user that is able to diagnose a problem that has caused the error and thus positioned to remedy the problem.

Accordingly, with this technology, an optimized process for automatically generating audit records of data transfer events in order to validate data delivery and to facilitate monitoring and compliance with applicable regulations is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for automatically generating an audit report for an event, the method being implemented by at least one processor, the method comprising:
receiving, by the at least one processor, a notification that a first data transfer event has commenced;
obtaining, by the at least one processor, intended destination and an intended timing of the first data transfer event;
submitting, by the at least one processor to a records repository, a first request for at least one record that relates to the first data transfer event;
receiving, by the at least one processor in response to the first request, the at least one record;
comparing, by the at least one processor, the intended destination and the intended timing with the at least one record;
generating, by the at least one processor based on a result of the comparing, an audit report that relates to the first data transfer event; and
transmitting, by the at least one processor to at least one predetermined destination, the audit report;
wherein when the result of the comparing indicates that the intended destination and an intended timing is accurate and that the first data transfer event has been successful, the audit report includes information that relates to an actual destination and an actual timing of the first data transfer event;
wherein when the result of the comparing indicates that there is an error associated with the first data transfer event, the audit report includes an error alert and the at least one predetermined destination includes a work station that is associated with at least one user that is affected by the error.

2-4. (canceled)

5. The method of claim 1, further comprising displaying the audit report on a digital dashboard that functions as a user interface (UI) for a user that is associated with the at least one predetermined destination.

6. The method of claim 5, further comprising displaying, in conjunction with the audit report on the digital dashboard, second information that relates to an entirety of a customer journey that relates to the first data transfer event.

7. The method of claim 1, further comprising generating, based on the intended destination and an intended timing and the audit report, a response to a request to prove compliance with an applicable governmental regulation.

8. The method of claim 1, wherein the obtaining comprises extracting the intended destination and an intended timing from an interaction with a customer that corresponds to the first data transfer event.

9. The method of claim 8, further comprising capturing a legal consent from the customer to indicate that the customer has successfully received correct and complete data as a result of the interaction.

10. A computing apparatus for automatically generating an audit report for an event, the computing apparatus comprising:
a processor;
a memory;
a display; and
a communication interface coupled to each of the processor, the memory, and the display,
wherein the processor is configured to:
receive, via the communication interface, a notification that a first data transfer event has commenced;
obtain intended destination and an intended timing of the first data transfer event;
submit, to a records repository, a first request for at least one record that relates to the first data transfer event;
receive, in response to the first request via the communication interface, the at least one record;
compare the intended destination and an intended timing with the at least one record;
generate, based on a result of the comparison, an audit report that relates to the first data transfer event; and
transmit, to at least one predetermined destination via the communication interface, the audit report;
wherein when the result of the compare indicates that the intended destination and an intended timing is accurate and that the first data transfer event has been successful, the audit report includes information that relates to an actual destination and an actual timing of the first data transfer event;
wherein when the result of the compare indicates that there is an error associated with the first data transfer event, the audit report includes an error alert and the at least one predetermined destination includes a work station that is associated with at least one user that is affected by the error.

11-13. (canceled)

14. The computing apparatus of claim 10, wherein the processor is further configured to cause the display to display the audit report on a digital dashboard that functions as a user interface (UI) for a user that is associated with the at least one predetermined destination.

15. The computing apparatus of claim 14, wherein the processor is further configured to cause the display to display, in conjunction with the audit report on the digital dashboard, second information that relates to an entirety of a customer journey that relates to the first data transfer event.

16. The computing apparatus of claim 10, wherein the processor is further configured to generate, based on the intended destination, the intended timing, and the audit report, a response to a request to prove compliance with an applicable governmental regulation.

17. The computing apparatus of claim 10, wherein the processor is further configured to obtain the intended destination and the intended timing from an interaction with a customer that corresponds to the first data transfer event.

18. The computing apparatus of claim 17, wherein the processor is further configured to capture a legal consent from the customer to indicate that the customer has successfully received correct and complete data as a result of the interaction.

19. A non-transitory computer readable storage medium storing instructions for automatically generating an audit report for an event, the storage medium comprising a first set of executable code which, when executed by a processor, causes the processor to:
receive a notification that a first data transfer event has commenced;
obtain intended destination and an intended timing of the first data transfer event;
submit, to a records repository, a first request for at least one record that relates to the first data transfer event;
receive, in response to the first request, the at least one record;
compare the intended destination and an intended timing with the at least one record;
generate, based on a result of the comparison, an audit report that relates to the first data transfer event; and
transmit, to at least one predetermined destination, the audit report;
wherein when the result of the compare indicates that the intended destination and an intended timing is accurate and that the first data transfer event has been successful, the audit report includes information that relates to an actual destination and an actual timing of the first data transfer event;
wherein when the result of the compare indicates that there is an error associated with the first data transfer event, the audit report includes an error alert and the at least one predetermined destination includes a work station that is associated with at least one user that is affected by the error.

20. (canceled)
